(19) United States
(12) Patent Application Publication
(10) Pub. No.: US 2020/0331205 A1
(43) Pub. Date: Oct. 22, 2020

(54) CALIBRATING HEAT SENSORS

(71) Applicant: HEWLETT-PACKARD DEVELOPMENT COMPANY, L.P., Houston, TX (US)

(72) Inventors: Albert TRENCHS MAGANA, Sant Cugat del Valles (ES); Juan Manuel ZAMORANO, Sant Cugat del Valles (ES); Michele VERGANI, Sant Cugat del Valles (ES)

(73) Assignee: HEWLETT-PACKARD DEVELOPMENT COMPANY, L.P., Houston, TX (US)

(21) Appl. No.: 16/087,704

(22) PCT Filed: Jul. 24, 2017
(86) PCT No.: PCT/US2017/043482

§ 371 Date: Sep. 24, 2018

(51) Int. Cl. B29C 64/393; G01K 1/02; G01J 5/10; B33Y 50/02; B29C 64/245; B29C 64/153

(52) U.S. Cl. CPC B29C 64/393; G01K 1/026; G01J 5/10; G01J 2005/0048; B29C 64/245; B29C 64/153; B33Y 50/02

(57) ABSTRACT

Method and devices for calibrating heat sensors are provided. The heat sensors may measure, from a distance, temperatures of build materials arranged on build platforms. Using the heat sensors, remote temperature measurements of regions may be acquired from a distance. Using temperature sensors integrated in the build platforms, local temperature measurements of regions of the build platforms may be acquired. The local temperature measurements may be compared with the remote temperature measurements to calculate differences. Correction factors associated with the calculated differences may then be applied when acquiring temperature measurements using the heat sensors.

### BACKGROUND

Additive manufacturing techniques may generate a three-dimensional object on a layer-by-layer basis through the solidification of a build material. In examples of such techniques, build material is supplied in a layer-wise manner and a solidification method may include heating the layers of build material to cause melting in selected regions. In other techniques, other solidification methods, such as chemical solidification methods or methods of binding materials, may be used. In some examples, the temperature of the build material is increased prior to the melting process.

### BRIEF DESCRIPTION

Some non-limiting examples of the present disclosure are described in the following with reference to the appended drawings, in which:

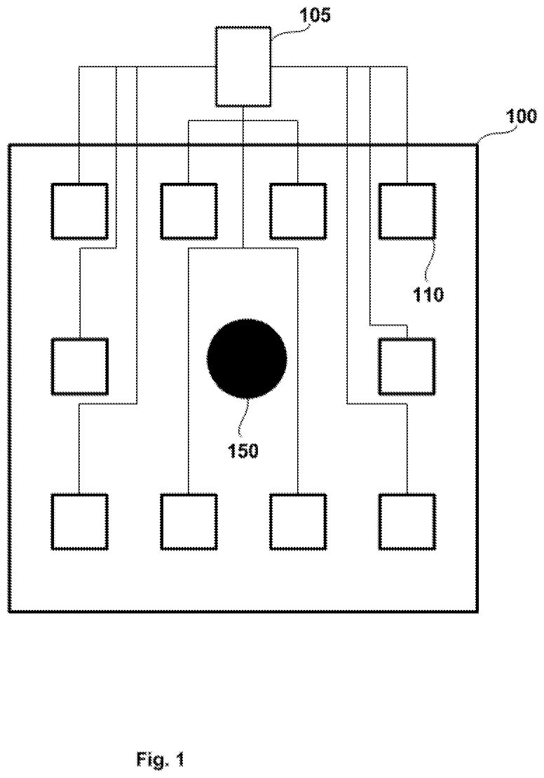

FIG. 1 schematically illustrates an example heating element structure used in 3D printing systems.

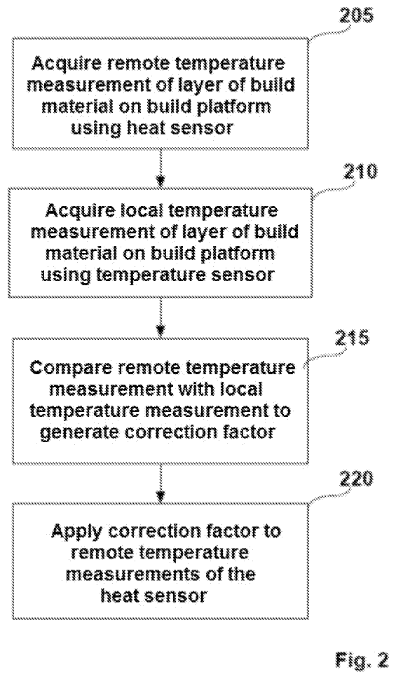

FIG. 2 is a flow chart of a method of calibrating a heat sensor, according to an example.

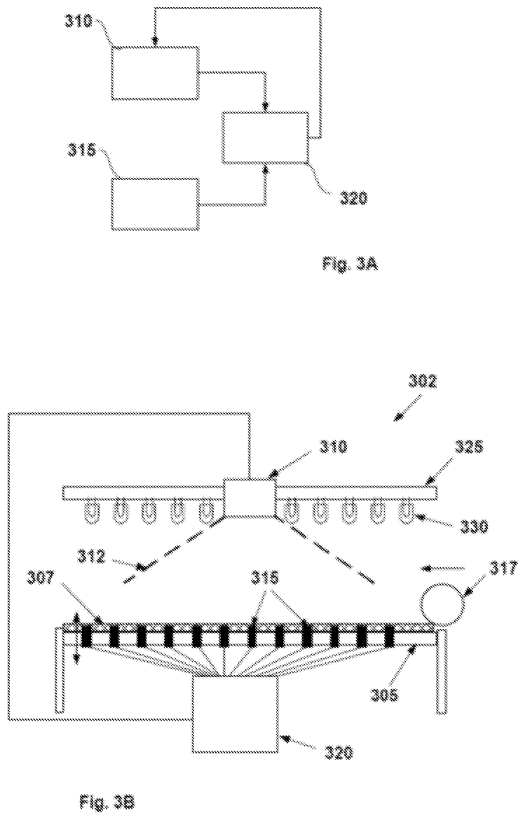

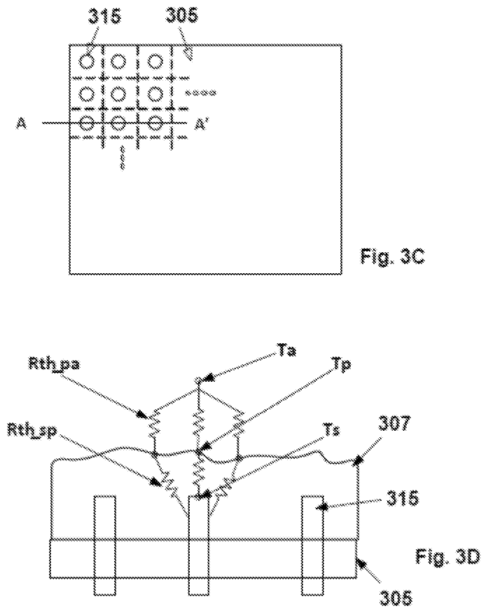

FIG. 3A schematically illustrates a heat sensor calibration circuit according to an example.

FIG. 3B schematically illustrates a 3D printing system with heat sensor calibration, according to an example.

FIG. 3C schematically illustrates a top view of a build platform with temperature sensors distributed in a mesh configuration in regions of the build platform.

FIG. 3D schematically illustrates a cross section of a build platform with temperature sensors and thermal resistance indicators.

### DETAILED DESCRIPTION

In some 3D printing processes a layer of a build material in the form of a particle material, e.g. powder, is laid down on a build platform of a fabrication chamber. Then a fusing agent is selectively applied where the particles are to fuse together. The layer of build material is subsequently exposed to fusing energy. The process is then repeated until a part has been formed. In some 3D printing systems a heating structure is used to heat the top layer of build material to a uniform temperature just below the melting point of the build material and before fusing energy is applied. A heating element structure, for example mounted over the build platform may be used for heating. In other examples, a scanning, fusing and warming lamp configuration is used. Some heating element structures have arrays of heating elements that are selectively controllable to provide energy in the form of heat to the build platform.

FIG. 1 schematically illustrates a heating element structure proposed in 3D printing systems. The heating element structure 100 may have an array of heating elements 110 arranged on a support structure. The heating element structure 100 may include a plurality of individual lamps, or heating elements 110. In the example shown in FIG. 1, the heating element structure 100 includes ten individual heat elements 110. The heating elements may be heating lamps, for example halogen lamps to radiate power in the near-infrared range, or infrared Light Emitting Diode (LED) lamps. However, other heat sources may be used, such as infrared bar radiators or any other radiation source or component configured to generate heat for increasing a temperature of at least a portion of the fabrication chamber. The support structure may form part of a top cover of a printing chamber. During operation of the 3D printing system, a layer of build material may be formed on a build platform. Then a fusing agent may be deposited, or printed, on a layer of build material formed on the build platform. Then the heating elements may be controllable to heat the layer of build material on the build platform. Controlling the heating elements may comprise individual switching of the heating elements or modulating the power emanating from the heating elements. The base may include a heat sensor 150, located for example at the center of the base, to measure the temperature on the build platform. The heat sensor 150, in some examples, may be a thermopile infrared (IR) sensor, capable of detecting absolute temperatures or temperature changes of a target, such as the print bed. The heat sensor 150 may include, or may be connected to, an imaging device, such as a charge-coupled device (CCD), capable of generating and/or recording a visual image representative of the detected temperature or temperature change for at least a portion of the print bed and/or build material on the print bed. In other examples, the heating element structure 100 may include multiple heat sensors 150 for measuring temperatures or detecting temperature changes of a target, which may be located among the heat elements 110 or elsewhere within, or remote from, the lamp assembly. The heat sensor 150 may, in some examples, register a temperature change for those portions of the print bed at which the temperature changes by a defined threshold amount, or at which the temperature changes to more than a defined threshold value.

In a 3D printing system, a fusing agent is applied on portions of the top layer of build material (e.g. powder). The fusing agent acts as a heat absorber to absorb more heat than portions on which no fusing agent is present, The action causes those portions with fusing agent to melt and fuse. The heat is applied at predefined temperatures or temperature ranges so that the build material to be fused. Heating at temperatures below or above a predefined temperature or temperature range, may degrade the quality of the printed product. A way to maintain the heating temperature within the prescribed temperature ranges is by measuring accurately the surface temperature of the printing area.

The heat sensor 150 may be used to monitor the powder temperature. The heat sensor 150 may be designed to measure temperature from a distance by detecting an object's infrared (IR) energy. The heat sensor 150 may comprise thermopile sensors that may convert the temperature radiation of an object surface to an electrical signal (voltage) by thermocouples, e.g. by using the thermoelectric or Seebeck effect. The sensor's output voltage may be related to the objects temperature and emissivity (radiation) as well as to the sensor chip temperature (housing temperature) and surrounding temperature (radiation) and may be calculated by the following equation:

VS=K*ε(TOn−TSn) (Equation 1)

where, VS may be the sensor output voltage, K may be a constant apparatus factor, ε may be the object's emissivity, TO may be the object's temperature, TA may be the ambient (surrounding) temperature, TS may be the sensor (housing) temperature and n may be an exponent corresponding to the temperature dependency of the signal voltage.

According to the above formula, the parameters K, TA & TS may either be measured by external sensors or may be predetermined and remain constant over time. However, the object emissivity (ε) may depend on the build material properties. Even if the theoretical emissivity for an object may be provided, e.g. in a datasheet of the object, the emissivity may change over time, from one material to another or when an agent is printed on the object.

Therefore, in order to obtain accurate temperature measurements a calibration process may be performed periodically. Such calibration process may be performed at the beginning of each printing process, e.g. during formation of the first layers.

FIG. 2 is a flow chart of a method of calibrating a heat sensor, according to an example. In block 205, a remote temperature measurement of the region from a distance using the heat sensor may be acquired. The heat sensor may measure, from a distance, temperatures of a layer of build material arranged on a build platform. In block 210, a local temperature measurement of a region of the build platform using a temperature sensor integrated in the build platform may be acquired. In block 215, the local temperature measurement may be compared with the remote temperature measurement to calculate a difference. In block 220, when the heat sensor is acquiring temperature measurements from the build platform, a correction factor associated with the calculated difference may be applied.

FIG. 3A schematically illustrates a heat sensor calibration circuit according to an example, The heat sensor calibration circuit 300 may comprise a heat sensor 300. The heat sensor 300 may remotely acquire temperature measurements on regions of a build platform. The heat sensor calibration circuit 300 may further comprise one or more temperature sensors 315. The temperature sensors 315 may be integrated in the build platform to locally acquire temperature measurements on the regions of the build platform, respectively. The heat sensor calibration circuit 300 may further comprise a controller 320. The controller 320 may be coupled to the temperature sensors 315 and to the heat sensor 310. The controller 320 may receive temperature measurements from the heat sensor 310 and from the temperature sensors 315, for one or more regions of the build platform. The controller 320 may compare the corresponding received temperature measurements and generate correction values or factors for the heat sensor 310 in response to differences in the compared measurements. The controller 320 may then apply the generated correction factors to the heat sensor 310 measurements.

FIG. 3B schematically illustrates a 3D printing system with heat sensor calibration, according to an example. The 3D printing system may comprise a 3D printer 302 and a build platform 305. The 3D printer may comprise a heating element structure 325, a roller 317 and a controller 320. Build material 307 may be deposited, e.g. spread by the roller 317, on the build platform 305. The heating element structure 325 may comprise heat sensor 310, e.g. a thermal camera, to remotely acquire temperature measurements on regions of the build platform, and heating elements 330. Temperature sensors 315 may be integrated in the build platform 305 to locally acquire temperature measurements on various regions of the build platform 305, respectively. The controller 320 may be coupled to the temperature sensors 315 and to the heat sensor 310. The controller may comprise circuitry, such as a processor and a memory storage, and may receive temperature measurements, from the heat sensor 310 and from the temperature sensors 315, for build platform regions, compare the corresponding received temperature measurements and apply correction factors to the heat sensor measurements in response to differences in the compared measurements.

The build platform 305, may contain as many temperature sensors 315 as may be the number of zones the thermal camera 310 may remotely measure. FIG. 3C is a top view of a build platform 305 with temperature sensors 315 distributed in a mesh configuration in regions of the build platform 305. Each temperature sensor may measure the surrounding powder's temperature, associated to a zone.

By using external temperature sensors located on the build platform, e.g. the build platform of a 3D printing system, the powder surface temperature may be accurately measured because the thermal resistance from powder to sensor is very low. This temperature value may be compared with the temperature measurements received from the heat sensor, e.g. the thermal camera, in order to calculate and apply a factor correction per region or zone of the printing surface.

FIG. 3D schematically illustrates a cross section of a build platform with temperature sensors and thermal resistance indicators. In order to get an accurate powder's surface temperature the calibration process may be carried out during the first layers of powder deposited on the build platform to assure that the thermal camera measurement point Tp is close enough to the temperature sensor measurement point Ts. Thus, the thermal resistance Rth_sp of the powder may be assumed to be lower than the thermal resistance Rth_pa of the air, so that the temperature Ts measured by the temperature sensor and temperature Tp at the surface of the powder layer may be considered to have the same value.

The calibration process may start once enough powder is deposited onto the build platform and the powder's temperature has reached a steady state. Then, temperature Ts obtained by the temperature sensor 315 and the measurement obtained from the thermal camera may be compared and a calibration factor may be calculated per each zone. When further layers are deposited, the controller may apply the calculated calibration factor for each zone.

Additionally, this method can be used to obtain calibration factors of different agents by, for instance, printing the powder deposited above a sensor with an agent and by comparing local and remote temperature measurements when the powder is printed with the agent.

In an example application, in a 3D printing system, the temperature may be regulated within 12 regions or zones of the build platform. In order to accurately calibrate the thermal camera across the build platform, one thermopile sensor, e.g. a negative temperature coefficient (NTC) sensor, may be used per each zone in order to calibrate the thermal camera. In one example, the thermal camera used may have an accuracy of +/−3% or +/−3° C. (+/−12° C. at 400° C.). By using high resolution temperature sensors the accuracy may be improved and provided in a range of +/−2.5° C. at 400° C. Therefore, in this example, this method may improve the thermal camera temperature acquisition accuracy by almost 5 times.

The example implementations discussed herein allow for accurate measurement of the temperatures on a build platform of a 3D printing system. For a certain build platform, the proposed calibration method may allow for lower energy consumption and for improved quality of the finished printed object. Thus, they may improve the efficiency of a 3D printing system.

It will be appreciated that examples described herein may be realized in the form of hardware or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disc or magnetic tape. It will be appreciated that the storage devices and storage media are examples of machine-readable storage that are suitable for storing a program or programs that, when executed, implement examples described herein. Accordingly, some examples provide a program comprising code for implementing a system or method as claimed in any preceding claim and a machine readable storage storing such a program. Still further, some examples may be conveyed electronically via any medium such as a communication signal carried over a wired or wireless connection.

All of the features disclosed in this specification (including any accompanying claims, abstract and drawings), and/or all of the operations of any method or process so disclosed, may be combined in any combination, except combinations where at least some of such features and/or operations are mutually exclusive.

Each feature disclosed in this specification (including any accompanying claims, abstract and drawings), may be replaced by alternative features serving the same, equivalent or similar purpose, unless expressly stated otherwise.

Although a number of particular implementations and examples have been disclosed herein, further variants and modifications of the disclosed devices and methods are possible. For example, not all the features disclosed herein are included in all the implementations, and implementations comprising other combinations of the features described are also possible. As such, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. Method of calibrating a heat sensor, the heat sensor to measure from a distance temperature of build material arranged on a build platform, the method comprising:
acquiring a remote temperature measurement of the region from a distance using the heat sensor;
acquiring a local temperature measurement of a region of the build platform using a temperature sensor integrated in the build platform;
comparing the local temperature measurement with the remote temperature measurement to calculate a difference;
applying a correction factor associated with the calculated difference when acquiring temperature measurements using the heat sensor.

2. Method according to claim 1, comprising acquiring multiple temperature measurements of multiple regions of the build platform using multiple sensors, respectively, each temperature sensor integrated in the respective region of the build platform.

3. Method according to claim 2, comprising comparing the multiple temperature measurements with respective remote temperature measurements from the heat sensor to calculate multiple differences.

4. Method according to claim 3, comprising applying multiple correction factors for the multiple regions, respectively.

5. Method according to claim 1, comprising applying a layer of build material on the build platform and measuring the temperature of the layer of built material using the heat sensor and the temperature sensor.

6. Method according to claim 5, wherein applying a layer of build material comprises applying a layer of powder material.

7. Method according to claim 6, comprising depositing an agent on the layer of powder material and obtaining a calibration factor for the combination of agent and powder material.

8. Method according to claim 1, comprising distributing temperature sensors in the build platform to acquire multiple local temperature measurements.

9. A heat sensor calibration circuit for a 3D printing system comprising:
a thermal camera to remotely measure temperature on regions of a build platform;
temperature sensors integrated in the build platform to locally measure temperature on the regions of the build platform, respectively;
a controller, coupled to the temperature sensors and to the thermal camera, to receive temperature measurements, from the thermal camera and from the temperature sensors, for build platform regions, compare the corresponding received temperature measurements and apply correction factors to the thermal camera measurements in response to differences in the compared measurements.

10. The thermal camera calibration circuit according to claim 9, wherein the temperature sensors are distributed in the build platform in a mesh structure.

11. The thermal camera calibration circuit according to claim 9, wherein the thermal camera comprises a thermopile infrared sensor.

12. The thermal camera calibration circuit according to claim 9. wherein each temperature sensor comprises a sensor portion extending above the build platform up to a height lower than a height of a deposited layer of build material.

13. A 3D printer comprising:
a powder depositor, to deposit a layer of powder on a build platform;
a lamp structure, to be mounted over the build platform to heat the layer of powder on the build platform,
a thermal camera, to remotely acquire temperature measurements of the layer of powder on the surface of the build platform;
a controller to receive measurements from the thermal camera and from temperature sensors integrated in the build platform to measure temperature of the powder on the build platform and apply correction factors to the thermal camera measurements.

14. The 3D printer according to claim 13, wherein the thermal camera is arranged with the lamp structure.

15. A 3D printing system comprising a 3D printer comprising
a powder depositor, to deposit a layer of powder on a build platform,
a lamp structure, to be mounted over the build platform to heat the layer of powder on the build platform,
a thermal camera, to remotely acquire temperature measurements of the layer of powder on the surface of the build platform, and
a controller to receive measurements from the thermal camera and from temperature sensors integrated in the build platform to measure temperature of the powder on the build platform and apply correction factors to the thermal camera measurements; and
the 3D printing system comprising a build platform with temperature sensors integrated in the build platform.
